(19) United States
(12) Patent Application Publication
(10) Pub. No.: US 2004/0050218 A1
(43) Pub. Date: Mar. 18, 2004

(54) Tool for turning a T-Handle lock assembly

(76) Inventor: Frederick Napoli, Lake Zurich, IL (US)

Correspondence Address: Frederick Napoli, P.O. Box 632, Lake Zurich, IL, 60047, US

(21) Appl. No.: 10/610,124

(22) Filed: Jun. 30, 2003

Related U.S. Application Data
(60) Provisional application No. 60/393,080, filed on Jul. 1, 2002.

(51) Int. Cl. B25B 13/48

(52) U.S. Cl. 81/176.2

(57) ABSTRACT

A tool (10) for turning a T-bar portion (40) of a T-Handle lock assembly includes a shaft (12) and a forward-projecting portion (14,16,20). The shaft (12) is intended for connection to a motorized tool (30), such as a cordless drill. The forward-projecting portion (14,16,20) is preferably “U” shaped and is intended for mating with the T-bar portion (40). During operation, the forward-projecting portion (14,16,20) rotates the T-bar portion (40) in response to rotation of the shaft (12) by the motorized tool (30), thus allowing a user to quickly open and close a vending machine without any repetitive or strenuous manual effort.

### RELATED APPLICATIONS

This application claims priority to U.S. provisional patent application Serial No. 60/393,080, filed Jul. 1, 2002 and entitled “Tool for Rotating a T-Handle Lock Assembly.”

### FIELD OF THE INVENTION

The present invention relates to the general subject of lock assemblies used in vending machines and related equipment. More particularly, the present invention relates to a tool for turning a T-Handle lock assembly.

### BACKGROUND OF THE INVENTION

T-Handle lock assemblies are used extensively in the vending industry for securing the door panels on equipment such as vending machines for dispensing soft drinks, snacks, and other items. The T-Handle mechanism provides a cost effective, reliable, and secure locking system for such equipment. The development and applications of the T-Handle are described in numerous patents, including U.S. Pat. No. 4,552,001 (Roop), U.S. Pat. No. 4,899,561 (Myers), U.S. Pat. No. 5,921,119 (Myers, et al.), and U.S. Pat. No. 6,068,305 (Myers, et al.). The wide use of T-handle lock assemblies is attested to by the fact that dimensional standards for the assemblies have been established by the National Automatic Merchandising Association (NAMA) and the American Society of Testing Materials (ASTM).

In a typical application, the T-Handle mechanism is situated in the door panel of a vending machine. The T-Handle mechanism includes a small rectangular bar (hereinafter referred to as a “T-bar”) and a threaded rod that is perpendicularly attached to the T-bar. The T-bar serves as a gripping handle for manual turning. The threaded rod has a hollow tubular section into which is inserted a lock tumbler core that latches and deploys once the threaded rod has been fully tightened and the T-bar has been snapped into its nest. The threaded rod mechanism serves the purposes of providing self-alignment between the door panel and the cabinet of the vending machine, and of drawing the door panel and the seal of the vending machine cabinet together to provide an airtight and weather-tight seal.

A major problem with T-Handle assemblies as currently used is that a great deal of repetitive manual effort is required in order to open or close the door panel. More specifically, the T-bar must be manually rotated through a large number of half-turns turns in order to fully loosen or tighten the threaded rod. Additionally, considerable amounts of rotational force and torque must be applied by the user in providing the required rotations. Clearly, such manual turning is time-consuming. Moreover, such repetitive and strenuous manual effort is highly undesirable from the standpoint of occupational health, especially in view of the required wrist manipulations. Thus, significant impetus exists for an approach that overcomes these disadvantages.

To date, at least one attempt has been made to reduce the effort associated with the procedure of manually turning a T-Handle mechanism. U.S. Pat. No. 4,918,784 (Cude) discloses a T-Handle turner device that includes an eccentrically mounted rotatable handle and a hollow body for receiving the rectangular bar portion of the T-Handle assembly. In practice, Cude's device allows a user to rotate the T-bar in a substantially continuous manner (i.e., without having to go through discrete half-turns). Consequently, it appears that Cude's device not only allows for quicker loosening or tightening of a T-Handle, but also reduces the range and intensity of wrist manipulations. Nevertheless, Cude's device still requires repetitive manual effort.

What is needed therefore is a device that not only provides for rapid loosening and tightening of a T-Handle lock assembly, but that also eliminates any repetitive and strenuous manual exertion associated with the same. Such a device would represent a significant advance over the prior art.

### BRIEF DESCRIPTION OF THE DRAWINGS

FIG. 1 is a left front perspective view of a tool for turning a T-Handle assembly, in accordance with a preferred embodiment of the present invention.

FIG. 2 is a right rear perspective view of the tool described in FIG. 1, in accordance with a preferred embodiment of the present invention.

FIG. 3 is a perspective view illustrating an intended use of the tool described in FIGS. 1 and 2, showing the tool secured in a chuck of a portable electric drill and about to be inserted over a T-bar portion of a T-Handle lock assembly that has been unlocked and released into an un-nested position, in accordance with a preferred embodiment of the present invention.

FIG. 4 is a perspective illustrating an intended use of the tool described in FIGS. 1 and 2, showing the tool inserted over the T-bar portion of an unlocked T-Handle lock assembly and engaged into the position of operation, in accordance with a preferred embodiment of present invention.

FIG. 5 is a perspective view illustrating an intended use of the tool described in FIGS. 1 and 2, showing the tool secured in the chuck of a portable electric drill and being used to turn the T-bar, in accordance with a preferred embodiment of the present invention.

### DETAILED DESCRIPTION OF THE PREFERRED EMBODIMENTS

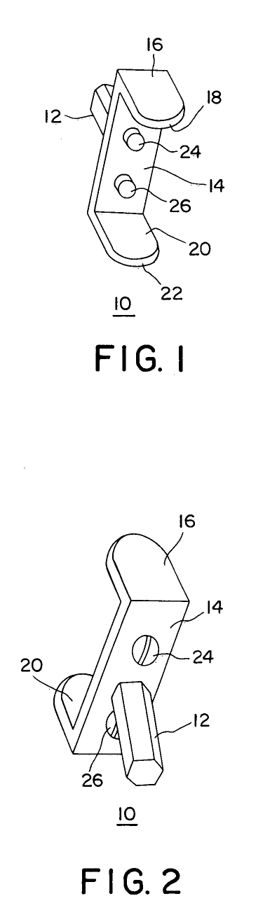

A tool 10 for turning a T-Handle lock assembly is described in detail in FIGS. 1 and 2. Tool 10 includes a shaft 12 and a forward-projecting portion 14,16,20. Shaft 12 is adapted for connection to a motorized tool, such as a cordless drill or a cordless screwdriver. Forward-projecting portion 14,16,20 is coupled to shaft 12 and is adapted for mating with a T-bar portion of the T-Handle lock assembly. During operation, in response to rotation of shaft 12 by the motorized tool, forward-projecting portion 14,16,20 rotates the T-bar portion.

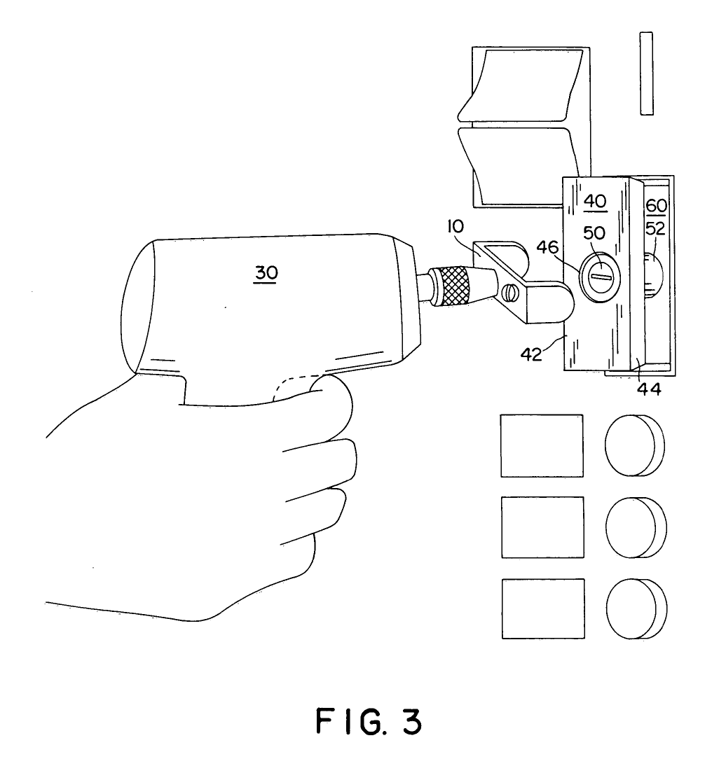

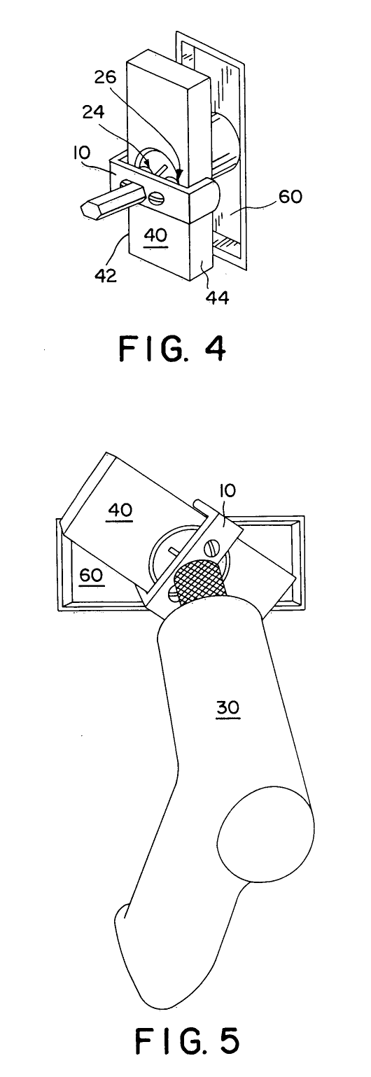

As described in FIGS. 1 and 2, forward-projecting portion 14,16,20 comprises a cross-member 14 and two tips 16,20. Cross-member 14 is attached to shaft 12. Forward-projecting 14,16,20 may be fabricated by a single piece of metal bar stock that is bent to have a shallow “U” shape configuration so as to conform to the shallow rectangular cross section of the T-bar handle (see FIGS. 3-5). More particularly, tips 16,20 are disposed substantially parallel to each other and substantially perpendicular to cross-member 14. During use of tool 10, tips 16,20 butt up against opposing vertical sides 42,44 (see FIG. 3) of the emerged T-bar 40 to lightly grip T-bar 40 and thereby transfer the rotational force applied to shaft 12 by a motorized tool 30 into a means of turning a threaded rod portion 52 of the T-Handle assembly.

During operation, when the shaft 12 is rotated in a clockwise direction, forward-projecting portion 14,16,20 likewise rotates. Consequently, T-bar 40 and threaded rod 52 rotate, drawing T-bar 40 closer to its nest 60. This causes the T-Handle mechanism to draw the door toward the cabinet portion of the vending machine and, eventually, to compress and thereby provide an airtight seal between the door and the cabinet portion of the vending machine. Conversely, when shaft 12 is rotated in a counterclockwise direction, the rotation releases the door from the closed position in which the cabinet seal is compressed, T-bar 40 is drawn away from nest 60, and, eventually, the threaded rod portion 52 of the T-Handle is released from a bracket attached to the cabinet portion of the vending machine. In this way, tool 10 allows a user to open and close a vending machine quickly and without any repetitive or strenuous manual effort.

Preferably, shaft 12 is welded to cross-member 14 and is centrally positioned for balanced rotation of tool 10. Preferably, shaft 12 has a hexagonal cross-section and is sized to fit a standard chuck of a portable drill or portable screwdriver. The end of shaft 12 that is intended for insertion into the chuck is slightly beveled in order to facilitate insertion into the chuck.

Preferably, tips 16,20 have rounded ends 18,22 with an approximately semi-circular shape. The rounded end 18,22 provide a margin of safety, making tool 10 less hazardous while rotating, and less likely to tear fabric or cause injury if tool 10 is stored in the user's pocket.

Preferably, tool 10 further includes two locator pins 24,26 that are attached to cross-member 14. Locator pins 24,26 are positioned longitudinally on the central axis of cross-member 14 and spaced equidistant from the point at which shaft 12 is attached to cross-member 14. The spacing between locator pins 24,26 is chosen to be a little less than the radius of the recess in lock cylinder chamber 50.

Turning now to FIGS. 3-5, when tool 10 engages T-bar 40, locator pins 24,26 project slightly into a shallow recess in lock cylinder chamber 50 that is left once the lock has been secured into its position of deployment. The span occupied by pins 24,26, being slightly narrower than the bore of the lock cylinder, touches lightly upon the lip 46 of the recess during tool rotation. Locator pins 24,26 not only serve to prevent tool 10 from sliding and keep tool 10 centered on the rotational axis of threaded rod 52 during loosening and tightening, but also provide a slight gripping effect while still allowing for some misalignment in the placement of tool 10 and in the T-Handle mechanism itself. This gripping effect is useful and necessary in that, in order to be loosened, the T-Bar must be drawn outward (i.e., away from nest 60) to engage the threaded rod portion 52, which in turn threads through a bracket (not shown in the drawings) attached to the vending machine cabinet. Significantly, while locator pins 24,26 reach into the recess of the lock cylinder chamber 50, they do not make actual contact with the surface of the lock tumbler therein. This allows the tool to “float” somewhat, thereby providing further allowance for misalignment, and allowing the tips of tool 10 to find a grip on the side surfaces 42,44 of the T-bar 40.

In a preferred embodiment, as illustrated in FIGS. 1 and 2, locator pins 24,26 are realized by screws that pass through holes drilled through cross-member 14, and that screw into internally threaded collars that receive them on an opposing side of cross-member 14. Alternatively, locator pins 24,26 may be implemented by conventional two-piece rivets that are fastened through suitable holes in cross-member 14.

Preferably, in order to enhance the aforementioned gripping effect, the entire forward-projecting portion of tool 10 (i.e., cross-member 14, tips 16,20, and locator pins 24,26) is given a non-slip surface by coating it with a suitable anti-slip substance, such as urethane rubber. Alternately, an enhanced gripping effect may be achieved by knurling or cross-hatching those surfaces of cross-member 14 and tips 16,20 that come into contact with the T-bar.

Tool 10 works well with both conventional T-Handle assemblies and the newer T-Handle assemblies that feature a T-bar handle that is attached at a slightly tilted angle to the threaded rod portion of the lock handle mechanism. Tool 10 works well in accommodating any disparities in the rotation of the threaded rod mechanism among different machines tested. Moreover, because of the non-slip coating, marring of the finished surfaces on the T-bar is prevented.

Although the present invention has been described with reference to certain preferred embodiments, numerous modifications and variations can be made by those skilled in the art without departing from the novel spirit and scope of this invention.

What is claimed is:

1. A tool for turning a T-Handle lock assembly, comprising:
a shaft adapted for connection to a motorized tool; and
a forward-projecting portion that is coupled to the shaft and adapted for mating with a T-bar portion of the T-Handle lock assembly, wherein the forward-projecting portion is operable to rotate the T-bar portion in response to rotation of the shaft by the motorized tool.

2. The tool of claim 1, wherein the forward-projecting portion is substantially “U” shaped.

3. The tool of claim 1, wherein the forward-projecting portion comprises:
a cross-member that is coupled to the shaft; and
a pair of tips coupled to the cross-member, wherein the tips are disposed substantially parallel to each other and substantially perpendicular to the cross-member.

4. The tool of claim 3, wherein the tips include rounded ends having a substantially semi-circular shape.

5. The tool of claim 3, wherein the forward-projecting portion further comprises a pair of locator pins that are coupled to the cross-member and positioned substantially equidistant from the shaft.

6. The tool of claim 5, wherein the locator pins comprise one of: (i) screws; and (ii) rivets.

7. The tool of claim 1, wherein the forward-projecting portion is coated with an anti-slip substance.

8. The tool of claim 1, wherein the forward-projecting portion is coated with urethane rubber.

9. The tool of claim 1, wherein the forward-projecting portion includes surfaces that are knurled.

10. The tool of claim 1, wherein the forward-projecting portion includes surfaces that are crosshatched.

11. The tool of claim 1, wherein the shaft has a substantially hexagonal cross-section and is sized to fit a standard chuck of a motorized tool.

12. The tool of claim 1, wherein the motorized tool is one of: (i) a screwdriver; and (ii) a drill.

13. A tool for turning a T-Handle lock assembly, comprising:
a shaft adapted for connection to a motorized tool; and
a forward-projecting portion that is adapted for mating with a T-bar portion of the T-Handle lock assembly and that is operable to rotate the T-bar portion in response to rotation of the shaft by the motorized tool, the forward-projecting portion comprising:
a cross-member that is coupled to the shaft;
a pair of tips coupled to the cross-member, wherein the tips are disposed substantially parallel to each other and substantially perpendicular to the cross-member; and
a pair of locator pins that are coupled to the cross-member and that are positioned substantially equidistant from the shaft.

14. The tool of claim 13, wherein the tips include rounded ends having a substantially semi-circular shape.

15. The tool of claim 14, wherein the locator pins comprise one of: (i) screws; and (ii) rivets.

16. The tool of claim 15, wherein the forward-projecting portion is coated with an anti-slip substance.

17. The tool of claim 14, wherein the forward-projecting portion includes surfaces that are knurled.

18. The tool of claim 14, wherein the forward-projecting portion includes surfaces that are crosshatched.

19. The tool of claim 16, wherein the motorized tool is one of: (i) a cordless screwdriver; and (ii) a cordless drill.

20. A tool for turning a T-Handle lock assembly, comprising:
a shaft adapted for connection to a cordless motorized tool; and
a forward-projecting portion that is adapted for mating with a T-bar portion of the T-Handle lock assembly, the forward-projecting portion being coated with an anti-slip substance, the forward-projecting portion comprising:
a cross-member that is coupled to the shaft;
a pair of tips coupled to the cross-member, wherein the tips are disposed substantially parallel to each other and substantially perpendicular to the cross-member, each of the tips including rounded ends; and
a pair of locator pins that are coupled to the cross-member and that are positioned substantially equidistant from the shaft.
